(19) United States
(12) Patent Application Publication
(10) Pub. No.: US 2002/0149510 A1
(43) Pub. Date: Oct. 17, 2002

(54) Method and apparatus for the protection of mobile military facilities

(76) Inventor: Rudolf Salzeder, Piding (DE)

Correspondence Address: Patrick C. Keane, BURNS, DOANE, SWECKER & MATHIS, L.L.P., P.O. Box 1404, Alexandria, VA, 22313-1404, US

(21) Appl. No.: 10/114,951

(22) Filed: Apr. 4, 2002

(30) Foreign Application Priority Data
Apr. 4, 2001 (DE) 10117007.6-15

(51) Int. Cl. G01S 7/36; G01S 7/38

(52) U.S. Cl. 342/13; 342/14; 342/15; 342/16; 342/17; 342/53; 342/54; 342/52

(57) ABSTRACT

The present invention relates to a method for the protection of mobile military facilities, in particular military bridges, against target-seeking guided weapons equipped with various threat sensors, wherein the mobile military facilities are equipped with active and passive anti-sensors for detecting a threat by approaching target-seeking guided weapons and computing their trajectories and determining suitable intercept coordinates for deploying countermeasures. Moreover a mobile dirigible launcher furnished with various decoy effective agent ammunitions is provided in the surroundings of the facility to be protected and/or immediately on the said facility. Depending on the threat, an effective agent ammunition suited for misleading the identified threat sensor is deployed in the calculated trajectory of the approaching target-seeking guided weapons in an amount and in the location of the determined intercept coordinates, that is adequate for diverting the target-seeking guided weapons from the object to be protected. Even where the threat sensor mechanism is not known, the defense system deploys all kinds of decoy ammunitions and is capable of diverting the approaching guided missile from its target.

The present invention relates to a method for the protection of mobile military facilities against target-seeking guided weapons equipped with various threat sensors in accordance with the preamble of claim 1, and an apparatus for implementing the method in accordance with the preamble of claim 10.

In order to protect military targets, such as in particular land, air and water vehicles, against unmanned missiles with intelligent, sensor-guided target-seeking heads, phantom targets designed for the corresponding sensor mechanism have for some time now been used for misleading such target-seeking guided missiles.

In defense against IR-guided target-seeking missiles, so-called IR phantom targets are being used. The like IR phantom targets are described, for example, in DE 34 21 692 C2 and DE 42 38 038 C1 to the assignee of the present application.

In defense against radar-guided target-seeking missiles, so-called chaffs are moreover employed which are described, for instance, in GB 1 584 438.

More recent target-seeking guided weapons are generally guided by sensors operating in a dual mode, which means they respond to both IR and radar signatures of targets.

In order to defend against such intelligent, “dual-mode” guided target-seeking missiles, corresponding dual-mode decoys are used which are capable of imitating both the IR signature of a target and its radar signature. The like dual-mode decoys are known, for instance, from DE 196 17 701 C1 and U.S. Pat. No. 5,835,051 to the assignee of the present application.

All hitherto known defensive measures against target-seeking guided weapons do, however, have in common that they are suited for land, air and water vehicles, however not for mobile military facilities such as, e.g., military bridges.

In view of the extraordinary dynamics of sensor technology, the short- and medium-term application of new, much more performing sensors for target acquisition and weapons guidance may be expected, which sensors will then be capable of targeting mobile military facilities. The rapid technological development moreover allows for the prognosis that guidance systems pertaining to the “high-tech area” and still very expensive at present, will be produceable at more and more low costs to thus become general equipment standard.

As a result, mobile military facilities such as military bridges will then also be threatened, because of their signature, particularly by guided weapons making use, besides the visual range, of the UV and IR ranges of the electromagnetic spectrum (laser illumination, ladar, imaging infrared), but radar-guided systems will also become available over a short or medium term.

At present there is no protection whatsoever for military bridges and other temporarily erected mobile military facilities against sensor-guided weapons. The air defense used is capable of fighting aircraft at short and medium distances only, however not weapons deployed by aircraft outside the reach of anti-aircraft artillery.

Currently there is no development or procurement project in the army for the protection of military bridges and other military objects against sensor-guided ammunitions, neither in the “hard-kill” nor “soft-kill” ranges.

It is therefore the object of the present invention to moreover provide an effective defense for mobile military facilities such as, e.g., military bridges, against intelligent, target-seeking guided missiles,.

In terms of method, this object is achieved through the characterizing features of claim 1. In terms of apparatus, this objected is achieved through claim 10.

The present invention relates to a method for the protection of mobile military facilities against target-seeking guided weapons equipped with various threat sensors, wherein

the mobile military facilities are equipped with active and passive anti-sensors for detecting a threat by approaching target-seeking guided weapons;

the trajectories of the detected target-seeking guided weapons are computed by means of a computer, and suitable intercept coordinates for deploying countermeasures are determined;

at least one mobile dirigible launcher furnished with various decoy effective agent ammunitions is provided in the surroundings of the facility to be protected and/or immediately on the said facility;

upon detection, the threat sensors of the target-seeking guided weapons are classified into

a) identifiable threat sensors; and

b) non-identifiable threat sensors;

in case a), the dirigible launcher is driven so as to deploy at least one effective agent ammunition suited for misleading the identified threat sensor, in the calculated trajectories of the approaching target-seeking guided weapons in an amount and at the location of the determined intercept coordinates, that is adequate for diverting the target-seeking guided weapons from the object to be protected; and

in case b), the dirigible launcher is driven so as to deploy all kinds of the decoy effective agent ammunitions present in the launcher, in the calculated trajectories of the approaching target-seeking guided weapons in an amount and at the location of the determined intercept coordinates, that is adequate for diverting the target-seeking guided weapons from the object to be protected.

Moreover the present invention relates to an apparatus for implementing the above method, including:

active and passive anti-sensors for detecting a threat by approaching target-seeking guided weapons;

a computer for computing the trajectories of the detected target-seeking guided weapons and determining suitable intercept coordinates for deploying countermeasures; as well as

at least one mobile dirigible launcher furnished with various decoy effective agent ammunitions and provided in the surroundings of the facility to be protected and/or immediately on the said facility.

The present invention thus constitutes a so-called “soft-kill anti-sensor protection system” for defense against approaching guided missiles or guided bombs:

One or several passive or active warning sensors are mounted or placed on the facility to be protected, such as a military bridge, depending on the type of threat to be expected, direction of threat and object size. In the case of passive warning sensors, these may be laser and/or UV warners or the like, however may also be one or several active radar sensors or the like which detect approaching, sensor-guided ammunitions and identify them as a threat for the facility to be protected. The detected sensor signals, made up of type of threat, direction and—where necessary—distance, are passed on to the system computer. The latter determines the type of ammunition adapted to a threat, time and duration of deployment, time periods between shots, quantity of ammunition and direction of deployment, and passes the respective data on to the control unit of the dirigible launcher.

The dirigible launcher, loaded onto a transport means and, where necessary, equipped with its own energy supply, is loaded with uniform or different effective agent ammunition depending on the threat to be expected, and is hemispherically dirigible in all directions. The dirigible launcher may be arranged directly on the facility to be protected, however this is not mandatory. Thus the launcher may, for example, also be positioned in the vicinity of the facility to be protected. The launcher is furnished with at least one multiple ammunitions launching means. Two launching means are equally possible. At least eight magazines each including at least four launcher tubes/rounds are insertable into the launching means. Other magazine constellations are, of course, also possible. The control unit of the dirigible launcher has information about the loading condition of each single launcher tube (loaded, unloaded, type of ammunition). It selects the required launcher tubes with the required type of ammunition, and triggers launches at the required points of time with the necessary number of ammunitions, the necessary spacing between single shots, and the required duration of deployment into the required direction.

Against visually, UV and infrared guided weapons an effective agent ammunition is available for timed deployment of a multiplicity of infrared flare submunitions in order to generate an infrared clutter screen that brings about an obstruction of the line of sight between weapon guiding sensor and target in the UV, visual, and entire infrared ranges (thus including the laser range).

For defending against radar-guided weapons, chaff ammunition is deployed into the line of sight of the approaching missile within the corresponding distance window, whereby the sensor's line of sight to the target is obstructed. If the threat consists of “more intelligent” missiles, the same ammunition may be used as phantom target ammunition; in this case, one or several chaff ammunitions are deployed into the line of sight and then fed further in a semicircular “walk-off” with additional ammunitions such that the threatening missile will be diverted from the target.

If the type of sensor mechanism of the threatening weapon cannot be identified, then for instance an ammunition is available which contains both radar and infrared active mass and is correspondingly deployed as a multi-spectral means of obstructing the line of sight, or as a phantom target in the “walk-off technique”.

In a preferred embodiment of the present invention, the mobile military facilities encompass bridges, in particular military bridges, mobile garrisons, camps, depots, and airports.

The present invention is effective against threat sensors that encompass cameras in the visual and IR ranges, UV, IR, laser, ladar, as well as radar sensors.

The anti-sensors accordingly also include cameras in the visual and IR ranges, UV, IR, Laser, ladar and radar sensors.

It is particularly advantageous that active anti-sensors are deactivated upon detection by the threat sensors and identification by the computer as a new target.

The directing geometry of the launcher is preferably designed to be hemispherical, with the launcher being dirigible in all directions along the hemispherical surface.

As decoy effective agent ammunition, preferably IR flares, VIS and IR smokes, radar chaff, in particular chaffs, as well as multi-mode decoys are used which advantageously contain submunitions for building up clutter screens in order to obstruct the line of sight between a threat sensor and a facility to be protected.

For the launcher it is preferred to be mounted on a small vehicle or trailer.

As a preferred embodiment, the launcher is provided with its own energy supply and control unit.

The circumstance that the apparatus is mobile on land and capable of being airlifted, particularly by means of a helicopter, enhances its rapid and universal operability.

Additional advantages and features of the present invention result on the basis of the description of an embodiment and by referring to the drawing, wherein:

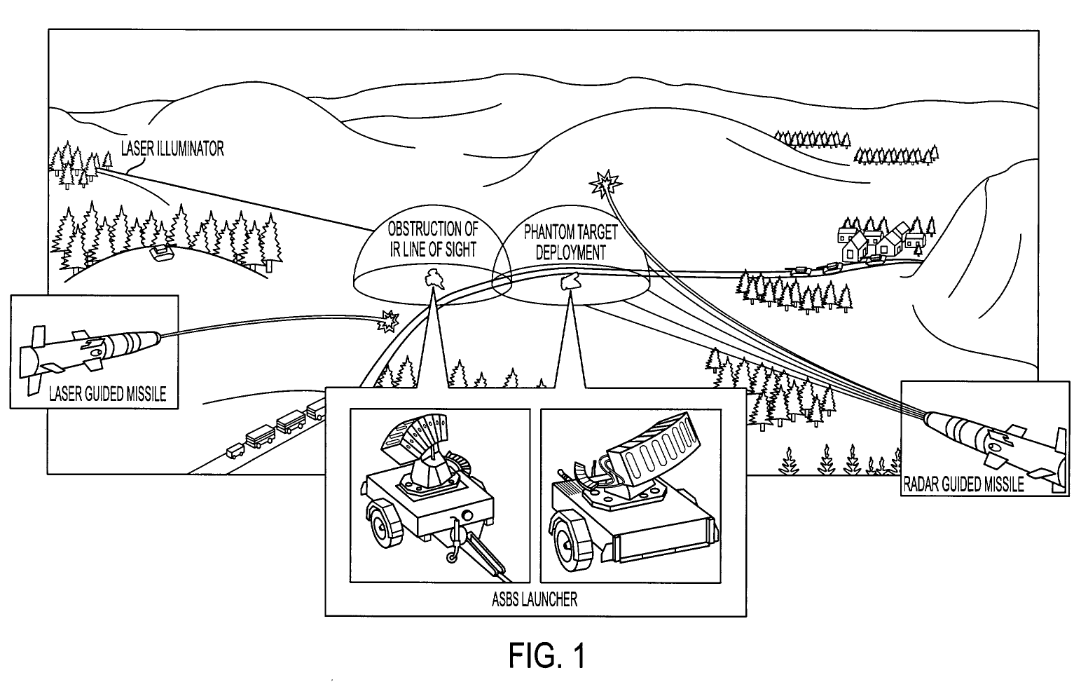

FIG. 1 shows a schematic representation for the protection of a military bridge by means of the method according to the invention.

Left-hand scenario of FIG. 1:

A laser illuminator deployed by the threatening mission weapons system levels on the military bridge (the laser illumination might also originate from the mission weapons system proper). A portion of this laser signal is reflected from the target to the laser seeking head, enabling it to home in on the target.

A laser warning sensor of the bridge senses the illuminating beam, passes on azimuth and elevation of the direction of threat to the system computer. Due to the fact that the signals originate in the laser warner, the system computer recognizes a laser threat and therefore selects (in the case of mixed charges) the infrared flare ammunition, determines azimuth and elevation for the infrared clutter screen, initiates aiming via the launcher control, in view of its lack of information concerning the distance of the threat immediately issues the fire command, and causes the clutter screen to be further fed over the longest possible pre-programmed period of time (in the protection of military bridges, a maximum of approx. 30 s is required).

The infrared clutter screen causes the illuminating laser beam to be absorbed, so that no guidance signal will arrive at the sensor of the approaching ammunition any more. The threatening ammunition either crashes immediately (this being the behavior of previously tested ones) or continues its flight without guidance, is subject to any extra-ballistic influences and moreover only has very slim chances of hitting the target.

Depending on the environment conditions, the clutter screen may, however, also bring about a certain reflection and/or dispersion of the laser radiation. In this case, the target-seeking head homes in on the clutter screen and detonates in its range, however not in the target.

Right-hand scenario of FIG. 1:

An active sensor identifies a threat by a radar-guided missile in azimuth, elevation, distance, and velocity. The signals are passed on to the system computer which selects the chaff ammunition, determines azimuth and elevation for deploying the radar phantom targets, determines the most favorable firing time, the “walk-off” direction and the timing and number of single rounds (and thus also the effective period) based on the knowledge of distance and velocity of the threat, and causes the launcher control to execute the commands.

The number of rounds and rate of fire of the chaff ammunition to be deployed into the line of sight of the target-seeking head are selected (programmed in advance) such that the RCS density will be adequate to prevent the arrival of a reflected radar signal from the target. The target-seeking head as of immediately receives its radar signals from the chaff phantom targets. If, now, the “walk-off” (programmed in advance to divert the threatening missiles into a non-critical area) is triggered such that the chaff phantom targets are deployed in a lateral direction so as to fuse with each other while they unfold and persist, then the target-seeking head will dwell on this respective most intense signal and be diverted in the “walk-off” direction.

An infrared-guided target-seeking head is diverted along the same principle by using infrared flare phantom target ammunition emitting an infrared signal that is more intense than the target's.

If the active sensor recognizes a threat in accordance with the above description, however without identification of the threat sensor mechanism of the target-seeking guided missile, then the system computer in the exemplary case selects a combined radar/infrared ammunition and fires an infrared clutter/chaff screen into the line of sight of the approaching missile. Hereby it is achieved that the infrared clutter/chaff screen becomes the target for the seeking head. Based on the distance and velocity information, the system computer determines the intercept coordinates, deployment time, number of rounds, rate of fire (and thus the effective period) and distribution of rounds for the infrared clutter/chaff screen.

If the sensor does not additionally receive any distance and velocity information, the infrared clutter/chaff screen is deployed as above, but with maximum rapidity and for the pre-programmed maximum duration.

1. A method for the protection of mobile military facilities against target-seeking guided weapons equipped with various threat sensors,
characterized in that
said mobile military facilities are equipped with active and passive anti-sensors for detecting a threat by approaching target-seeking guided weapons;
the trajectories of said detected target-seeking guided weapons are calculated by means of a computer, and suitable intercept coordinates for deploying countermeasures are determined;
at least one mobile dirigible launcher furnished with various decoy effective agent ammunitions is provided in the surroundings of said facility to be protected and/or immediately on the said facility;
upon detection, said threat sensors of said target-seeking guided weapons are classified into
a) identifiable threat sensors; and
b) non-identifiable threat sensors;
in case a), said dirigible launcher is driven so as to deploy at least one effective agent ammunition suited for misleading said identified threat sensor, in the calculated trajectories of said approaching target-seeking guided weapons in an amount and at the location of the determined intercept coordinates, that is adequate for diverting said target-seeking guided weapons from said object to be protected; and
in case b), said dirigible launcher is driven so as to deploy all kinds of decoy effective agent ammunitions present in said launcher, in the calculated trajectories of said approaching target-seeking guided weapons in an amount and at the location of the determined intercept coordinates, that is adequate for diverting said target-seeking guided weapons from said object to be protected.

2. The method according to claim 1, characterized in that said mobile military facilities encompass bridges, in particular military bridges, mobile garrisons, camps, depots, and airports.

3. The method according to claim 1 or 2, characterized in that said threat sensors encompass cameras in the visual and IR ranges, UV, IR, laser, ladar, and radar sensors.

4. The method according to any one of claims 1 to 3, characterized in that said anti-sensors encompass cameras in the visual and IR ranges, UV, IR, laser, ladar, and radar sensors.

5. The method according to claim 4, characterized in that active anti-sensors are deactivated upon detection by said threat sensors and identification by the computer as a new target.

6. The method according to any one of claims 1 to 5, characterized in that a launcher is used that is hemispherically dirigible in all directions.

7. The method according to any one of claims 1 to 6, characterized in that said decoy effective agent ammunition includes IR flares, VIS and IR smokes, radar chaff, in particular chaffs, and multi-mode decoys.

8. The method according to any one of claims 1 to 7, characterized in that said decoy effective agent ammunition contains submunitions.

9. The method according to any one of claims 1 to 8, characterized in that said effective agent ammunition is deployed in a time sequence, with clutter screens being generated to obstruct the line of sight between threat sensor and facility to be protected.

10. Apparatus for implementing the method according to any one of claims 1 to 9, including:
active and passive anti-sensors for detecting a threat by approaching target-seeking guided weapons;
a computer for computing the trajectories of said detected target-seeking guided weapons and determining suitable intercept coordinates for deploying countermeasures; and
at least one mobile dirigible launcher furnished with various decoy effective agent ammunitions and provided in the surroundings of said facility to be protected and/or immediately on the said facility.

11. The apparatus according to claim 10, characterized in that said launcher is hemispherically dirigible in all directions.

12. The apparatus according to claim 10 or 11, characterized in that said launcher is mounted on a small vehicle or trailer.

13. The apparatus according to any one of claims 10 to 12, characterized in that said launcher is provided with its own energy supply and control unit.

14. The apparatus according to any one of claims 10 to 13, characterized in that said apparatus is capable of being airlifted, in particular by means of a helicopter.
